(19) United States
(12) Patent Application Publication
(10) Pub. No.: US 2016/0131560 A1
(43) Pub. Date: May 12, 2016

(54) METHODS FOR PHENOTYPING OF INTACT BONES BY TISSUE CLEARING AND STAINING

(71) Applicant: California Institute of Technology, Pasadena, CA (US)

(72) Inventors: Viviana Gradinaru, La Canada Flintridge, CA (US); Bin Yang, Pasadena, CA (US); Jennifer Treweek, Pasadena, CA (US); Ken Chan, Pasadena, CA (US)

(73) Assignee: CALIFORNIA INSTITUTE OF TECHNOLOGY, Pasadena, CA (US)

(21) Appl. No.: 14/935,279

(22) Filed: Nov. 6, 2015

Related U.S. Application Data
(60) Provisional application No. 62/076,705, filed on Nov. 7, 2014.

(51) Int. Cl. G01N 1/30

(52) U.S. Cl. CPC G01N 1/30; G01N 2001/302

(57) ABSTRACT

In various embodiments, the present application teaches methods and kits for clearing and optionally subsequently visualizing tissue containing bone. In some embodiments, the method includes serially incubating cleared bone in refractive index matching solutions with progressively higher refractive indexes. In some embodiments, the methods teach immunolabeling and/or staining tissue containing bone and optionally visualizing the immunolabeled and/or stained tissue containing bone.

### CROSS REFERENCE TO RELATED APPLICATION

This application claims priority under 35 U.S.C. §119(e) from U.S. Provisional Patent Application No. 62/076,705, filed Nov. 7, 2014, the content of which is hereby incorporated herein by reference in its entirety.

### STATEMENT REGARDING FEDERALLY-SPONSORED RESEARCH

This invention was made with government support under Grant Nos. IDP20D017782-01 and 1R01AG047664-01 awarded by the National Institutes of Health. The government has certain rights in the invention.

### FIELD OF THE INVENTION

The present invention generally relates to the field of tissue preparation and characterization.

### BACKGROUND

The following description includes information that may be useful in understanding the present invention. It is not an admission that any of the information provided herein is prior art or relevant to the presently claimed invention.

Due to its calcified nature, most mammalian osseous tissue does not afford easy access to three-dimensional information. Visual representations of the spatial distribution and properties of cells within a bone sample must be obtained via the sectioning, labeling and imaging of thin tissue slices, and the reconstruction of these digital image datasets. Bone-sectioning, however is both physically challenging given the hard, fibrous nature of osseous tissue, and risks incurring extensive damage to the tissue sample. To this end, the PACT deCAL methods described herein allow for fixing, chemically clearing (via lipid extraction), decalcifying, immunolabeling, optically clearing (via refractive image matching), mounting, and imaging intact bone samples at high resolution, among other things. Cellular morphology, tissue architecture, macromolecular/cellular content, and biomolecule/protein antigenicity are all preserved under the methods described herein so that biological, immunological, and 3D structural properties of skeletal samples may be studied in healthy and diseased state.

### SUMMARY OF THE INVENTION

In various embodiments, the invention teaches a method, including: applying a fixing solution to a tissue including a bone of a subject; applying a hydrogel monomer solution to the tissue including the bone of the subject; applying a detergent solution to the tissue including the bone of the subject; and applying a solution including a calcium chelating agent to the tissue including the bone of the subject. In some embodiments, the method further includes applying a solution including an amino alcohol to the tissue the bone of the subject. In some embodiments, the solution including the amino alcohol includes N,N,N′,N′-Tetrakis(2-Hydroxypropyl)ethylenediamine. In some embodiments, the calcium chelating agent includes ethylenediaminetetraacetic acid (EDTA) and/or ethylene glycol tetraacetic acid (EGTA). In some embodiments, the hydrogel monomer solution includes 2-8% acrylamide. In some embodiments, the method further includes applying a photoinitiator solution including 2,2′-Azobis[2-(2-imidazolin-2-yl)propane]dihydrochloride to the tissue including the bone of the subject. In some embodiments, the method further includes placing the tissue including the bone of the subject into a substantially air-tight chamber, and introducing nitrogen into the substantially air tight chamber, thereby forming a de-gassed tissue including bone. In certain embodiments, the detergent solution includes 6-15% sodium dodecyl sulfate (SDS). In certain embodiments, the method further includes serially incubating the tissue including the bone of the subject in refractive index matching solutions (RIMS) with progressively higher refractive indexes (RIs), wherein the final RIMS in which the tissue including the bone of the subject is incubated has an RI of 1.46-1.52 or 1.38-1.46. In some embodiments, the tissue including the bone of the subject is first incubated in a RIMS of a first RI, thereby forming a primary RIMS treated tissue including bone, and the primary RIMS treated tissue including bone is subsequently incubated in a second RIMS with a second RI, wherein the second RI is higher than the first RI, thereby forming a secondary RIMS treated tissue including bone. In certain embodiments, the method further includes incubating the secondary RIMS treated tissue including bone in a third RIMS, thereby forming a tertiary RIMS treated tissue including bone, wherein the third RIMS has a higher RI than the first and second RIMS. In some embodiments, the first RIMS in which the tissue including the bone of the subject is incubated has an RI of 1.38-1.44. In some embodiments, the second RIMS in which the tissue including bone is incubated has an RI of 1.44-1.48. In certain embodiments, the tissue including bone is incubated in a third RIMS that has an RI of 1.47-1.52. In certain embodiments, one or more of the fixing solution, hydrogel monomer solution, and detergent solution are applied to the tissue including the bone of the subject through the subject's vascular system. In some embodiments, two or more of the fixing solution, hydrogel monomer solution, and detergent solution are applied to the tissue including the bone of the subject through the subject's vascular system. In certain embodiments, the calcium chelating agent is further applied to the tissue including the bone of the subject through the subject's vascular system. In some embodiments, the method further includes applying a solution including a primary antibody to the tissue including the bone of the subject, thereby forming a primary antibody bound tissue including bone. In certain embodiments, the method further includes washing the primary antibody bound tissue including the bone of the subject with a washing solution. In some embodiments, the method further includes applying a solution including a secondary antibody to the antibody bound tissue including the bone of the subject that has been washed with said washing solution, wherein the secondary antibody is labeled with a visualizable marker, thereby forming a secondary antibody bound tissue including bone. In certain embodiments, the visualizable marker is fluorescent. In some embodiments, the primary antibody is labeled with a visualizable marker. In certain embodiments, the method further includes visualizing the tissue including the bone of the subject with a microscope after the detergent solution has been applied. In some embodiments, the microscope is of a type selected from the group consisting of a confocal microscope, a light sheet microscope, an epi-fluorescent microscope, a dissecting microscope, and a wide-field fluorescence microscope with ApoTome. In some embodiments, the method further includes using a microscope to visualize the tissue including the bone of the subject that has been incubated in the final RIMS. In some embodiments, the microscope is of a type selected from the group consisting of a confocal microscope, a light sheet microscope, an epi-fluorescent microscope, a dissecting microscope, and wide-field fluorescence microscope with ApoTome. In certain embodiments, a multi-immersion objective with a correction collar adjusted to match the RI of the final RIMS is used to visualize the tissue including the bone of the subject.

In various embodiments, the invention teaches a kit, including three or more of (1) one or more components of a refractive index matching solution (RIMS), (2) ethylenediaminetetraacetic acid (EDTA) and/or ethylene glycol tetraacetic acid (EGTA), (3) acrylamide, (4) sodium dodecyl sulfate, and (5) instructions for clearing tissue including bone.

### BRIEF DESCRIPTION OF THE DRAWINGS

Exemplary embodiments are illustrated in the referenced figures. It is intended that the embodiments and figures disclosed herein are to be considered illustrative rather than restrictive.

FIGS. 1 A-1O depict, in accordance with an embodiment of the invention, a PAssive CLARITY Technique (PACT) set-up and procedure. To successfully hybridize tissue with hydrogel monomers via free radical polymerization, the sample and hydrogel solution can be incubated at 37° C. in an oxygen-depleted environment. This can be accomplished within an air-tight container that permits sample degassing. FIG. 1A depicts supplies for PACT chamber (left): 50 ml conical tube (large sample) or vacutainer (small sample), size 7 stoppers that fit the 50 ml conical tube, PTFE tubing, needles, syringes, and a razor blade or scissors to cut syringe in half. Construct a degassing line that will allow a sample tube to be evacuated of oxygen using the house vacuum and then placed under inert nitrogen atmosphere (FIGS. 1A-1D) FIG. 1B shows degassing lines. FIG. 1C shows small and large sample containers. FIG. 1D shows a closer view of the N2 line and venting needle. FIGS. 1E-1O The PACT procedure for sample degassing and hydrogel polymerization is as follows (FIG. 1E depicts materials for PACT procedures): prepare the hydrogel monomer solution, taking care to keep all reagents ice-cold; infuse the tissue sample with hydrogel monomer solution at 4° C.; As shown in FIG. 1F insert the vacuum line needle into the stopper and place the container under house vacuum for 5-10 minutes; remove the vacuum line and insert both a venting needle and the hypodermic needle, which is connected to the nitrogen gas line tubing (as shown in FIG. 1G); bubble nitrogen gas through the sample and solution for 5-10 minutes (as shown in FIG. 1H), ensuring that the venting needle allows excess pressure to escape from the PACT container; quickly remove both needles and place the sample and container in a 37° C. water bath for 1-3 hours (as shown in FIG. 1I)). Once the hydrogel has polymerized, pour off excess hydrogel (as shown in FIG. 1J), rinse the sample with 1×PBS and/or tissue off with a Kimwipe, section the sample (optional—as shown in FIG. 1K), and place the sample into a 50 ml conical filled with 8% SDS clearing buffer. Incubate at 37° C. in a shaking water bath until the sample is clear. Thoroughly wash the cleared sample, immunostain (optional), and then incubate the sample in RIMS to improve its optical clarity. FIG. 1L-1N shows an A4P0 rat brain slice passively clear in 8% SDS-PBS pH 8.5, at 37° C., FIG. 1L shows the rat brain slice at 0 h, FIG. 1M shows the rat brain slice at 48 h. FIG. 1N shows the rat brain slice at 96 h. FIG. 1O shows the rat brain slice after incubation in RIMS.

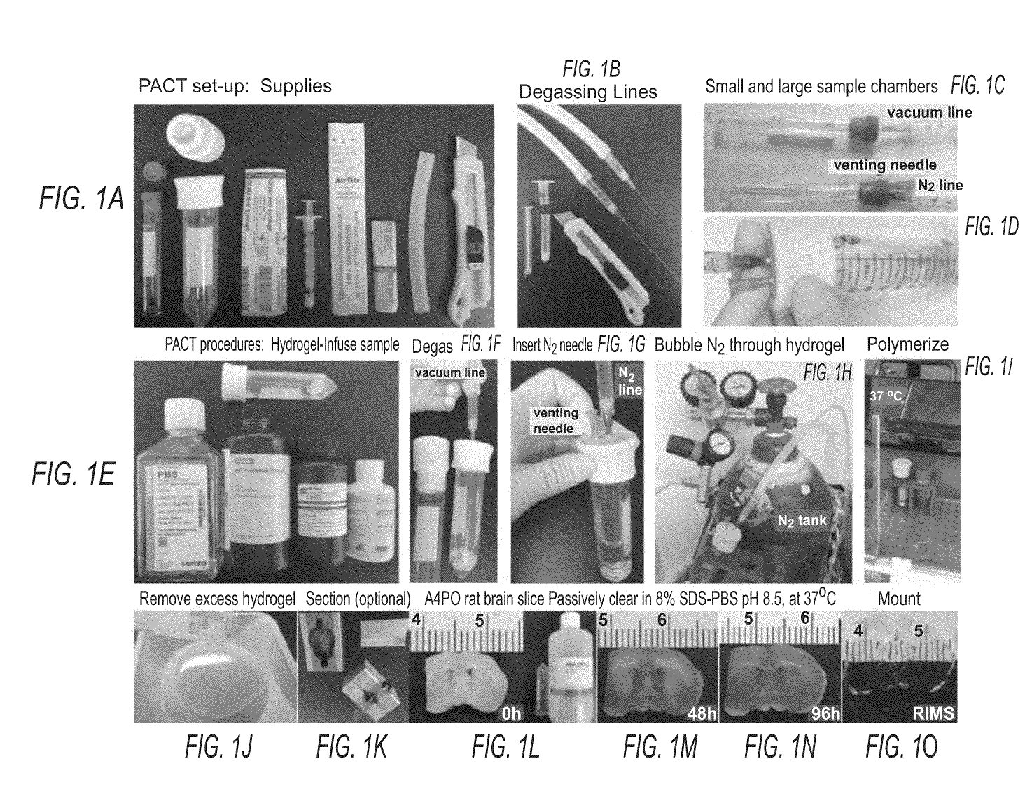

FIGS. 2A-2E demonstrate, in accordance with an embodiment of the invention, PACT-deCAL and optimized RIMS formulation for imaging decalcified bone samples. As shown in FIG. 2A, after perfusion fixation with 4% PFA, the right and left tibia bones of a mouse were dissected and post-fixed in 4% PFA overnight. One tibia was reserved as the uncleared control (as shown in FIG. 2A), while the other tibia bone was A4P0-embedded and cleared (as shown in FIG. 2B) according to PACT-deCAL, as follows. The tibia bone was first cleared in 8% SDS-PBS (pH 8) for 24 hours, then transferred into 0.1 M EDTA for 2 days, and finally cleared further in 8% SDS-PBS (pH 8) for 2 days at 37° C. The cleared bone was washed in 1×PBS 3 times over 1 day and incubated in PBS containing 1:200 DRAQ5 for 2 days at 37° C. The stained bone was quickly rinsed in 1×PBS, incubated in 1.49 RIMS overnight at 37° C. The brightfield image (as shown in FIG. 2B) depicts the resulting bone transparency via the placement of a ruler (small red box) underneath the tibia, wherein the tibia's outline on top of the ruler can be seen in the magnified inset of the ruler (large red box). The cleared tibia was imaged in two regions (yellow (as shown in FIG. 2D) and blue (as shown in FIG. 2C) boxes) on a Zeiss LSM 780 confocal with the LD LCI Plan-Apochromat 25×0.8 N.A. Imm Corr DIC M27 multi-immersion objective (w.d. 0.57 mm). As shown in FIG. 2E RIMS may be formulated with different concentrations of Histodenz™ in order to achieve a refractive index that aligns with the tissue density and light scattering properties of the sample to be imaged, as well as to the optical properties of the imaging set-up (objective lens with or without immersion media). RIMS with an RI˜1.47 is well-suited for most cleared soft tissues (blue tick mark), whereas cleared bones may be incubated in RIMS with RI˜1.48-1.52.

FIG. 3 demonstrates, in accordance with an embodiment of the invention, a limb (5 mm thick) of a mouse (˜8 months of age).

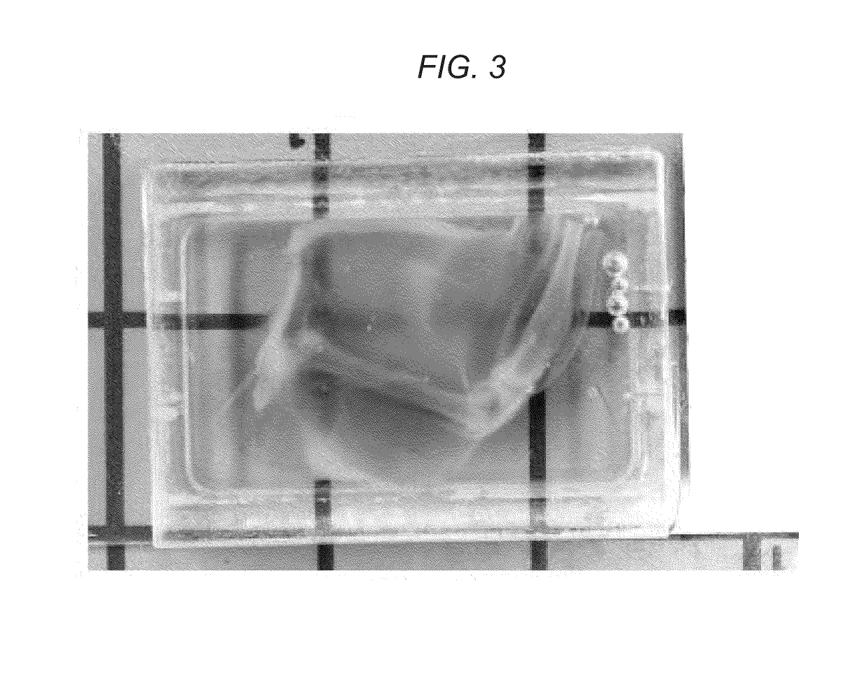

FIG. 4 demonstrates, in accordance with an embodiment of the invention, a rat femur after clearing. The text behind the cleared bone can be seen.

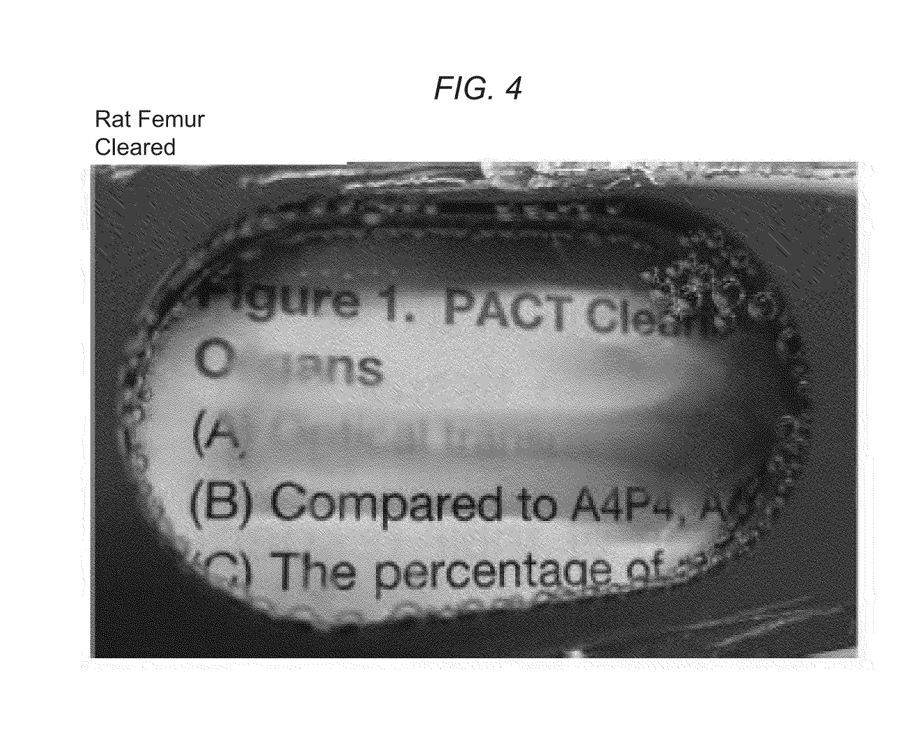

FIG. 5 demonstrates, in accordance with an embodiment of the invention, a stained and imaged intact cleared rat femur.

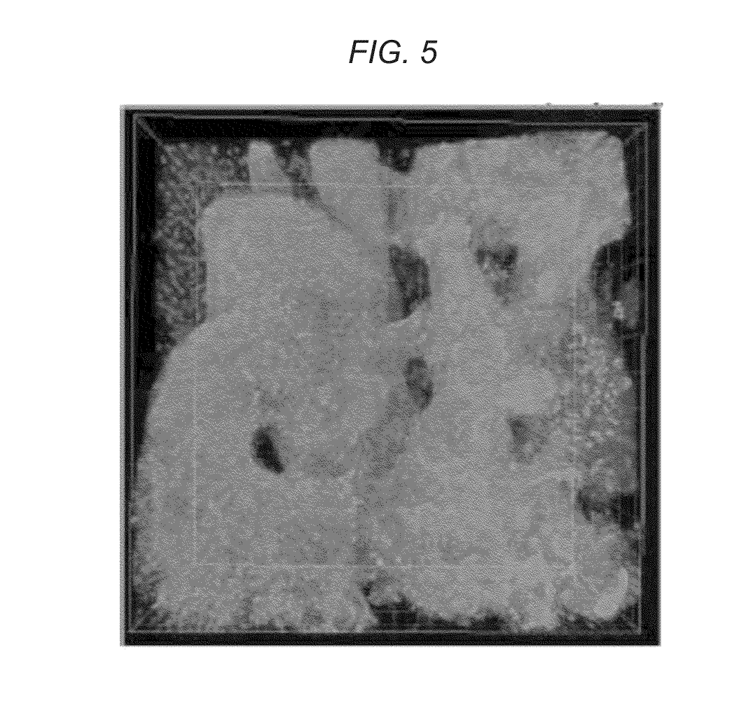

FIGS. 6A-6C demonstrate various embodiments of the invention. FIG. 6A shows mouse limbs that are perfused with 1×PBS followed by 4% PFA. Limbs are then post-fixed with 4% PFA. Samples 1-4 and 7 are hydrogel embedding with A4P0. Sample 5 is used as a control where it is neither decalcified nor chemically cleared. Sample 6 is used to measure the optical clearing with RIMS only. Samples 1-4 are then decalcified with the use of ethylenediaminetetraacetic acid (EDTA) or with ethylene glycol tetraacetic acid (EGTA) as a chelation reagent. EDTA or EGTA with a range from 0.1M to 0.2M in 1×PBS with a pH range of 7.5-9 were used as the conditions. Following chelation, samples 1-4 are chemically cleared with 8% SDS until optically transparent. Afterwards samples are washed repeatedly with 1×PBS until residual SDS is removed. FIG. 6B shows the results after PACT deCAL, and all samples are incubated in TO-PRO®-3 at 1:5000 in 1×PBS for 30 minutes. Samples are then quickly washed with 1×PBS. Finally, samples are immersed in RIMS 1.48 (FIG. 6C shows the resulting samples).

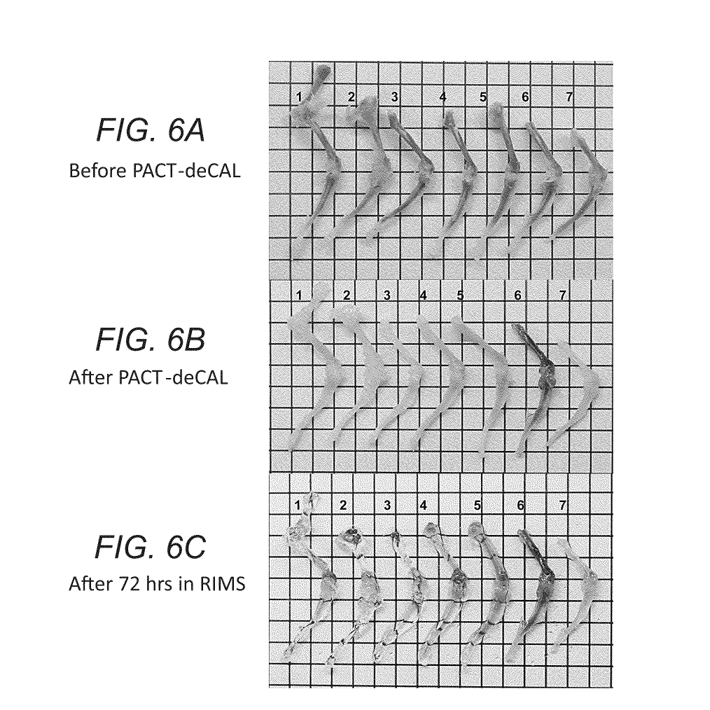

FIGS. 7A-7E demonstrate, in accordance with an embodiment of the invention, mouse femur after PACT deCAL with TO-PRO®-3 staining imaged on a Zeiss 780 confocal.

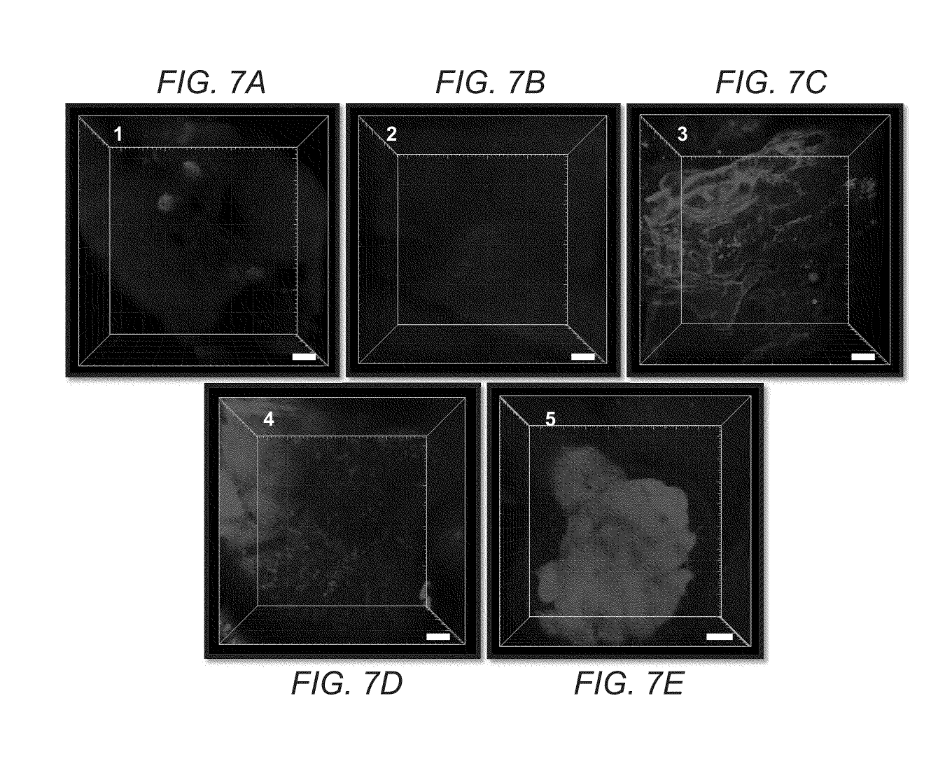

FIGS. 8A-8C demonstrate, in accordance with an embodiment of the invention, mouse femurs, tibias and L1-L4 of the vertebra column that have been cleared using a combination of chemical clearing with PACT deCAL and optical clearing using the amino alcohol N,N,N′,N′-Tetrakis(2-Hydroxypropyl)ethylenediamine preserve bone marrow. FIG. 8A Samples before PACT deCAL. FIG. 8B Samples after first decalcified by using 0.2M EGTA. Then samples are incubated in 25% w/w of N,N,N′,N′-Tetrakis(2-Hydroxypropyl)ethylenediamine with 8% SDS in 1×PBS at pH 8 for optical clearing of lipids and blood cells. FIG. 8C After PACT deCAL samples are incubated in RIMS 1.52.

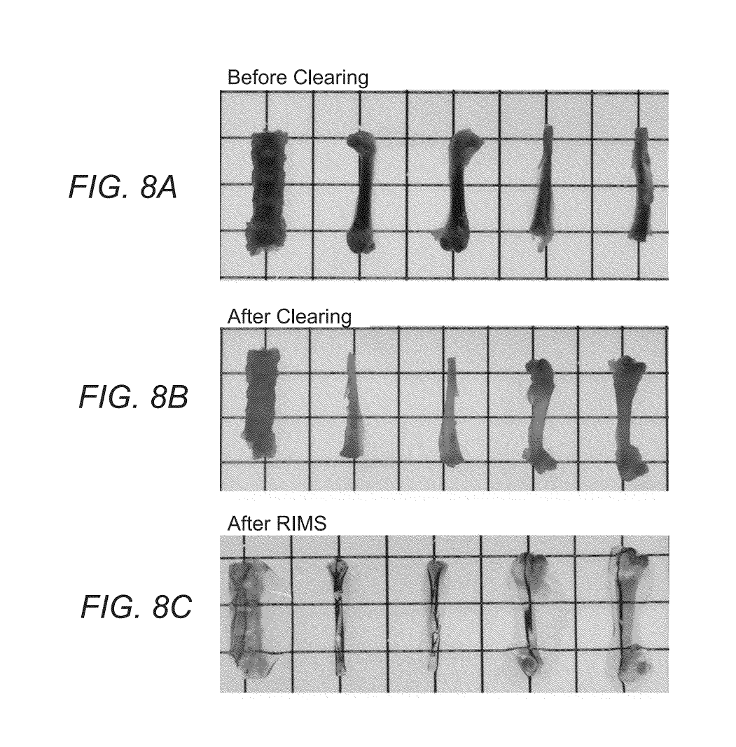

### DESCRIPTION OF THE INVENTION

All references cited herein are incorporated by reference in their entirety as though fully set forth. Unless defined otherwise, technical and scientific terms used herein have the same meaning as commonly understood by one of ordinary skill in the art to which this invention belongs. March, Advanced Organic Chemistry Reactions, Mechanisms and Structure 5^{th} ed.; and Guyton and Hall, Textbook of Medical Physiology 12^{th} ed., provide one skilled in the art with a general guide to many of the terms used in the present application.

One skilled in the art will recognize many methods and materials similar or equivalent to those described herein, which could be used in the practice of the present invention. Indeed, the present invention is in no way limited to the methods and materials described. For purposes of the present invention, certain terms are defined below.

As used herein, PACT is an acronym for PAssive CLARITY Technique.

As used herein, PARS is an acronym for Perfusion-assisted Agent Release in Situ.

As used herein, RIMS is an acronym for Refractive Index Matching Solution.

As used herein, PACT deCAL is an abbreviation of the term PACT delipidation and decalcification of bone.

“Mammal,” as used herein, refers to any member of the class Mammalia, including, without limitation, humans and nonhuman primates such as chimpanzees and other apes and monkey species; farm animals such as cattle, sheep, pigs, goats and horses; domesticated mammals, such as dogs and cats; laboratory animals including rodents such as mice, rats and guinea pigs, and the like. The term does not denote a particular age or sex. Thus, adult, newborn subjects, and unborn subjects whether male or female, are intended to be included within the scope of this term.

By way of additional background, owing to their intrinsic transparency, the worm Caenorhabditis elegans and the zebrafish Danio rerio provide scientists with an unobstructed, organism-wide view of tissue anatomy and cellular activity (e.g. via cell-type specific fluorescent labeling and genetically encoded calcium indicators) using conventional imaging techniques. In combination with their small size and genetic tractability, their whole-body transparency enables rigorous, high throughput investigations into how environmental, cellular, and genetic alterations influence biological processes from cellular signaling and apoptosis, to organism development and survival. By contrast, the comparatively large size and optical opacity of mammalian models generally has limited researchers to imaging snapshots of cellular organization on thin-sectioned tissue samples. However, it was hypothesized that if the bodies of these mammalian model organisms were to acquire the same level of optical transparency as zebrafish embryos, whole-body image datasets would theoretically become available to scientists for study.

Several methodologies for tissue clearing have been proposed for large-scale 3D mapping of tissue macromolecular content. Each of these protocols offers distinct advantages, such as: preserving tissue architecture, accommodating standard histological techniques or creating a computational workflow for acquiring and/or reconstructing thick-tissue image stacks. Building on the prior CLARITY technique and concepts for generating extractable tissue-hydrogel hybrids (as referenced and described in U.S. patent application Ser. No. 14/447,607, filed Jul. 30, 2014, which is hereby incorporated by reference herein in its entirety as though fully set forth), the trio of PACT (PAssive CLARITY Technique), PARS (Perfusion-assisted Agent Release in Situ), and RIMS (Refractive Index Matching Solution) were developed to offer a user-friendly, rapid approach to rendering whole organs and whole organisms transparent (see U.S. patent application Ser. No. 14/447,607). These methods preserve the macromolecular content of samples, enabling immunohistochemical, single-molecule RNA fluorescence in situ hybridization (smFISH), and small-molecule staining throughout thick tissues, stabilize tissue architecture, complement fluorescent labeling and imaging, and enable long-term storage.

In various embodiments, the present invention adds to previous clearing techniques by establishing compositions, methods, and kits specifically configured for delipidation and decalcification of bone. This process is called “PACT deCAL.”

In some embodiments, the method for clearing bone includes the steps of (1) bone preparation; (2) formation of a bone-hydrogel matrix; and (3) bone clearing. In some embodiments, the method for clearing bones begins after a bone-hydrogel has been formed by any method described or referenced herein. After bone is cleared, it may be imaged (and optionally optimized for imaging by incubation in one or more refractive index matching solutions (RIMS's)), assayed, and analyzed in numerous ways, as described and referenced herein.

### Tissue Preparation

With regard to tissue preparation, in various embodiments, an anesthetized (e.g. with Euthasol) subject is transcardially perfused with a solution that includes PBS (or an equivalently functioning alternative) at a concentration of 1× (1×PBS contains 10 mM PO₄³⁻), or with a solution that includes 0.1 M phosphate buffer (PB). In some embodiments, the solution including PBS or PB further includes heparin at a concentration of 1-20 U/ml, or 2-18 U/ml, or 4-16 U/ml, or 6-14 U/ml, or 8-12 U/ml, or 10 U/ml. In some embodiments, the hPBS or hPB further includes 0.1-1.0%, or 0.2-0.80%, or 0.3-0.6%, or 0.4-0.5% NaNO₂. In some embodiments, the hPBS solution includes 1×PBS, 0.5% NaNO₂ and 10 U/ml heparin (“hPBS”). In some embodiments, the heparinized phosphate-buffered solution includes 0.1 M PB, 0.5% NaNO₂ and 10 U/ml heparin (“hPB”). In certain embodiments, the solution used at this stage is from 0-25° C., or 4-23° C., or 6-21° C., or 8-19° C., or 10-17° C., or 12-15° C., or 13-14° C. In some embodiments, the solution is ice cold. In some embodiments, the subject is transcardially perfused with hPBS or hPB until the perfusate drains clear from the right atrium. In some embodiments, the perfusion pressure (flow rate) during transcardial perfusion should approximate the physiological pressure of the subject's circulatory system, and thus could vary greatly from one animal subject to the next. In some embodiments, the next step is to transcardially perfuse the subject with a fixative solution. In some embodiments, the fixative solution includes paraformaldehyde (PFA). Importantly, although PFA is specifically mentioned as a fixative that can be used throughout the present application, it is to be understood that in each instance in which PFA is mentioned, any comparable fixative to PFA could be used, including but in no way limited to Zinc formalin mixtures, Bouin and PFA supplemented with 0-2% glutaraldehyde. In some embodiments, the PFA solution includes 0.5-10%, or 1-9%, or 2-8%, or 3-7%, or 4-6%, or 5% PFA. In some embodiments, the PFA solution further includes 1×PBS or 0.1 M PB (or an equivalently functioning alternative). In some embodiments, the PFA solution includes 4% PFA in 1×PBS. In some embodiments, the PFA solution includes 4% PFA in 0.1 M PB. In some embodiments, 10-500 ml or more, or 20-400 ml, or 40-300 ml, or 60-200 ml, or 80-100 ml is transcardially perfused at a rate of 1-100 ml/min, or 10-90 ml/min., or 20-80 ml/min. or 30-70 ml/min., or 40-60 ml/min, or 50 ml/min, depending upon the size and condition of the subject, and the physiological pressure of the subject's circulatory system. In some embodiments, the solution including PFA is introduced transcardially at a temperature of 0-25° C., or 4-23° C., or 6-21° C., or 8-19° C., or 10-17° C., or 12-15° C., or 13-14° C. In some embodiments, ice cold PFA solution is introduced. In certain embodiments, for initial perfusion-fixation, gravity alone may be used to draw hPBS (or hPB) and PFA through rodent vasculature. In certain embodiments, the aforementioned solutions are used to incubate a bone-containing tissue of interest that has been excised from a subject, rather than introducing the solutions through the subject's vascular system as described above.

In certain embodiments, after the aforementioned treatments have been performed, a tissue sample containing bone (“bone sample”) is excised from a subject (assuming it hasn't already been excised, as indicated above). In certain embodiments, the bone sample is rid of connective tissue using surgical instruments or gauze. In some embodiments the bone sample once removed or removed and rid of connective tissue is incubated in a solution that includes PFA. In some embodiments, the PFA solution is 1-8%, 2-6%, or 3-4% PFA. In some embodiments, the PFA solution is 4% PFA. In certain embodiments, the bone sample is incubated in PFA at this stage for 1-24 hours, 4-18 hours, 6-16 hours, 8-14 hours, or 10-12 hours. In some embodiments, the bone sample is incubated in PFA at a temperature of 1-35° C. or 2-28° C., or 4-20° C. In certain embodiments, the bone sample is incubated in PFA for 1-2 hours at room temperature. In certain embodiments, the bone sample is then incubated in PFA for 12-36 hours at 4° C. In some embodiments, the bone sample is incubated in PFA for 10-12 hours at 4° C. After the bone sample has been incubated in PFA, a PFA-fixed bone sample is formed.

### Formation of a Bone-Hydrogel Matrix

In some embodiments, the next step in bone clearing is to form a bone-hydrogel matrix before decalcification. In some embodiments, a bone-hydrogel matrix is formed after the decalcification procedure described herein. In some embodiments, the PFA-fixed bone sample is transferred into a container containing a hydrogel solution. In some embodiments, the hydrogel solution is a hydrogel monomer solution that includes acrylamide at a concentration of from 1-20%, or 2-18% or 3-17%, or 4-16%, or 5-15%, or 6-14%, or 7-13%, or 8-12%, or 9-11%, or 10%. In some embodiments, the hydrogel solution includes PBS (or functional equivalent thereof). In certain embodiments, the hydrogel monomer solution includes A4P0. In certain embodiments, the hydrogel monomer solution further includes PFA at a concentration of 0.5-10%, or 1-9%, or 2-8%, or 3-7%, or 4-6%, or 5%. In certain embodiments, the hydrogel monomer solution does not include PFA. In some embodiments, the hydrogel monomer solution includes bisacrylamide. In other embodiments, the hydrogel monomer solution does not include bisacrylamide. In some embodiments, in order to increase the level of crosslinking without the addition of bisacrylamide or PFA to the hydrogel monomer solution, the hydrogel-infused bone sample is significantly degassed by removing residual oxygen from the bone sample and any container in which it has been placed. In some embodiments, degassing is accomplished by replacing oxygen in the solution and environment surrounding the bone sample with nitrogen. In some embodiments, the bone sample is incubated in a hydrogel monomer solution for 1 hour-5 days or more, 6 hours-3 days, or 12 hours-2 days. For large bones (e.g. a human femur or larger), incubation of one week to more than one month may be required, depending upon the size and density of the particular sample. In some embodiments, the bone sample is incubated in hydrogel monomer solution at a temperature of 0-10° C., 2-8° C., or 4-6° C. In some embodiment, the bone sample is incubated at a temperature of 4° C. for 12 hours. The above-described hydrogel embedding results in a bone-hydrogel sample. In some embodiments, the bone-hydrogel sample can be used for subsequent analysis, without executing further steps described herein. In other embodiments, the ensuing steps can be implemented. In some embodiments, the bone-hydrogel sample is produced by infusing the hydrogel monomer solutions described in this step into the subject's circulatory system, rather than by treating excised tissue containing bone.

### Tissue Delipidation

In certain embodiments, after the previously described hydrogel embedding, or after arriving at a bone-hydrogel sample by any other method known in the art (including by PARS or any other protocols discussed or referenced herein), the resulting bone-hydrogel sample is incubated in a clearing solution that includes a detergent. In some embodiments, the detergent may include SDS. In some embodiments, saponin, Triton X-100, Tween-20 and the like may be used as an alternative or in addition to SDS. In some embodiments, the clearing solution includes 1-20% SDS, or 2-18% SDS, or 3-17% SDS, or 4-16% SDS, or 5-15% SDS, or 6-14% SDS, or 7-13% SDS, or 8-12% SDS, or 9-11% SDS, or 10% SDS. In some embodiments, the clearing solution that includes SDS further includes PBS or 0.1 M PB (or a functional equivalent). In some embodiments, clearing may be performed in any convenient buffer that is compatible with the selected clearance method, e.g., saline, phosphate buffer, phosphate buffered saline (PBS), sodium borate buffer, boric acid buffer, citric acid buffer and the like. In some embodiments, the clearing solution that includes SDS includes 1×PBS (or a functional equivalent). In an embodiment, the clearing solution that includes SDS includes 10% SDS in 1×PBS. In some embodiments, the clearing solution that includes SDS has a pH of 6.5-9.5, or 7.0-9.0, or 8.0. In some embodiments, the clearing solution includes 10% SDS in 1×PBS and it has a pH of 8. In some embodiments, the bone-hydrogel sample incubating in the clearing solution is agitated during incubation by rocking, mixing, stirring, or the like. In certain embodiments, this stage of incubation is carried out at a temperature of 25-42° C. In some embodiments, the temperature at which the bone-hydrogel sample is incubated in the clearing solution is 37° C. In certain embodiments, the incubation temperature is maintained by placing a container containing the bone-hydrogel sample and clearing solution in a heated water bath. In some embodiments, the sample is incubated in the clearing solution for 1 hour-21 days, 2 hours-15 days, 3 hours-12 days, 6 hours-4 days, 12 hours-3 days, or 1-2 days. Importantly, the rate of tissue clearing depends on several parameters, including the inherent structural and biochemical properties of the tissue sample, the volume of the tissue sample, the hydrogel pore size and density of tissue-hydrogel crosslinking, and the clearing set-up (e.g. SDS concentration, incubation temperature, and pH of clearing buffer). In some embodiments, after the bone sample is incubated in the clearing solution, it is transferred to a calcium chelating solution. In some embodiments, the calcium chelating solution includes EDTA or EGTA, but other calcium chelating solutions could also be used without departing from the spirit of the invention. In some embodiments, bone samples are incubated in a calcium chelating solution (e.g. EDTA solution or EGTA solution) before any clearing solution. In some embodiments, the EDTA solution includes 0.025 M-1 M, or 0.05 M-0.75 M, or 0.075 M-0.5 M EDTA. In some embodiments, the EGTA solution includes 0.025 M-1 M, or 0.05 M-0.75 M, or 0.075 M-0.5 M EGTA. In some embodiments, the EDTA solution into which the bone sample is transferred includes 0.1 M, 0.2 M or 10% EDTA. In some embodiments, the EGTA solution into which the bone sample is transferred includes 0.1 M, 0.2 M or 10% EGTA. In certain embodiments, the EDTA or EGTA solution further includes PBS or PB (or a functional equivalent). In some embodiments, the EDTA solution into which the bone sample is transferred includes 0.1M EDTA in 1×PBS, and the solution is at pH 6.5-9.5, 7-9, or 8.0. In various embodiments, the bone sample is incubated in the EDTA or EGTA solution for a period of 0.1-21 days or more (depending upon the size and density of the bone) 0.2-18 days, or 0.3-16 days, or 0.4-10 days, or 0.5-6 days, or 0.4-5 days, or 0.5-4 days, or 0.6-3 days, or 0.7-2 days, or 0.8-1 day. In some embodiments, the bone sample is incubated in the EDTA solution for a period of 14 days. In certain embodiments, the EDTA or EGTA solution is changed 0-24, 1-16, 2-12, 3-10, 4-8, or 5-7 times per day. In some embodiments, the EDTA or EGTA solution is changed daily. In some embodiments, the bone sample is incubated in the calcium chelating solution (e.g. EDTA or EGTA) until it becomes soft and flexible, indicating that the bone has become substantially decalcified, thereby forming a substantially decalcified bone sample.

In various embodiments, the substantially decalcified bone sample is next incubated in a solution including 0.5-20% SDS, 1-18% SDS, 2-16% SDS, 3-15% SDS, 4-14% SDS, 5-13% SDS, 6-12% SDS, 7-11% SDS, 8-10% SDS, 9% SDS, or 10% SDS. In some embodiments, at this stage the solution that includes SDS is at a pH of 6-10, 7-9, or 8. In some embodiments, the solution that includes SDS further includes 1×PBS. In some embodiments, the substantially decalcified bone sample is incubated in the solution containing SDS at this stage for a period of 0.1-10 days, 0.2-9 days, 0.3-8 days, 0.4-7 days, 0.5-6 days, 0.6-5 days, 0.7-4.5 days, 0.8-4 days, 0.9-3 days, 1-2 days, or 2 days. In some embodiments, this incubation is performed at a temperature of 20-44° C., or 22-20° C., or 24-38° C., or 26-36° C., or 28-34° C., or 30-32° C. In some embodiments, the incubation is performed at a temperature of 37° C. In some embodiments, the temperature of the incubation is regulated by placing the solution in a container, which is in turn place into a water bath. In various embodiments, after this incubation period in a solution containing detergent (e.g. the SDS solutions indicated above), the substantially decalcified bone is incubated in a washing solution for a period of 1-72 hours, or 6-48 hours, or 8-24 hours, or 12-16 hours. In some embodiments, incubation at this stage is for a period of 24 hours. In some embodiments the washing solution includes PBS (or a functional equivalent). In some embodiments, 1×PBS is used at this stage. In some embodiments, the pH range of the solution in which the tissue sample is incubating at this stage is 6-10, or 7-9, or 8. In certain embodiments, the pH of the solution in which the tissue sample is incubating at this stage is 8. In some embodiments, the PBS (or alternative buffer) is exchanged 1-10 times or more per day, 2-8 times per day, 3-6 times per day, or 4-5 times per day. After this stage of treatment, the bone sample is considered to be cleared and washed. Once the bone sample has been cleared and washed, it may be stored in a storage solution with or without sodium azide and/or an alternative antimicrobial agent. In some embodiments, the storage solution includes 1×PBS (or a functional equivalent thereof. In certain embodiments, the storage solution contains sodium azide at a concentration of 0.0001-1%, 0.001-0.5%, or 0.01-0.05%. In some embodiments, the storage solution contains sodium azide at a concentration of 0.01%. In some embodiments, one or more antimicrobial agents, in addition to or instead of sodium azide, are included in the storage solution. In some embodiments, the sample is maintained in the storage solution at a temperature of 4-42° C., 6-40° C., 8-38° C., 10-36° C., 12-34° C., 14-32° C., 16-30° C., 18-28° C., 20-26° C., or 22-24° C. In some embodiments, the sample is maintained in the storage solution at a temperature of 21° C. In some embodiments, the sample may be maintained in the storage solution for a period of 0.1-60 days or more, 1-45 days, 5-40 days, 10-35 days, or 15-25 days. In some embodiments, the sample may be maintained in the storage solution for 1-2 days.

In some embodiments, bone-containing samples are incubated in a solution that includes an amino alcohol. In some embodiments, the amino alcohol is N,N,N′,N′-Tetrakis(2-Hydroxypropyl)ethylenediamine. In some embodiments, the solution includes N,N,N′,N′-Tetrakis(2-Hydroxypropyl)ethylenediamine in an amount ranging from 1-50%, 5-25%, 10-20%, or 15-18% w/w. In some embodiments the solution includes 25% w/w of N,N,N′,N′-Tetrakis(2-Hydroxypropyl)ethylenediamine. In some embodiments, the solution further includes a detergent described herein. In some embodiments, the solution includes SDS. In some embodiments the solution includes 2-12%, 4-10%, 6-8%, or 7% SDS. In some embodiments, the solution further includes a buffer described herein (e.g. PBS or PB). In some embodiments, the pH range of the solution containing the amino alcohol is 6-10. In some embodiments, the solution containing the amino alcohol includes 25% w/w of N,N,N′,N′-Tetrakis(2-Hydroxypropyl)ethylenediamine with 8% SDS in 1×PBS at pH 8. In certain embodiments, the solution is useful for optical clearing of lipids and blood cells in the bone-containing tissue sample. In some embodiments, the solution including the amino alcohol can be applied to the bone-containing tissue before and/or after treating the bone-containing sample with a calcium chelating agent as described above.

Considering that bone consists of approximately 16% collagen, in certain embodiments, bone is incubated in collagenase before or after any of the preceding clearing steps, in order to disrupt the collagen matrix.

Importantly, the decalcification step of incubating in a calcium chelating agent (e.g. EGTA and/or EDTA) may occur before or after delipidation. Further, decalcification and/or delipidation may be repeated, as necessary. Thus, in some embodiments, bone clearing may be achieved by decalcification followed by delipidation. In other embodiments, bone clearing may be achieved by delipidation followed by decalcification and optionally one or more additional iterations of delipidation with or without additional decalcification.

### Single-Cell Phenotyping of Cleared Tissues

The PACT-deCAL compositions and methods described above are amenable to most standard immunohistochemical protocols, including those involving one or more of a wide range of small-molecule dyes, primary antibodies, secondary antibodies, fluorescent labels, and other markers. Examples of nucleic acid stains that may be useful include, but are in no way limited to, dapi, Draq5, To-Pro and the like. Examples of antibodies that may be useful include, but are in no way limited to, those specific for osterix, collagen type I and IV, NG2 chondroitin sulfate proteoglycan, osteopontin, CD45, endomucin and the like. Examples of collagen stains that may be useful include, but are in no way limited to, picrosirius, trichrome, H&E, reticulin silver stain, tartrate resistant acid phosphatase for osteoclasts and alkaline phosphatase for osteoblasts

### Passive Histology

In certain embodiments, the bone-containing tissue can be incubated with a primary antibody cocktail in an IHC buffer. In some embodiments, a primary antibody dilution of 1:10-1000 or more, 1:20-500, 1:100-400, or 1:200-300 is used. In some embodiments, the bone-containing tissue can be incubated in a primary antibody cocktail in an IHC buffer for 0.01-15 days, 0.5-10 days, 1-5 days, or 2-4 days. In some embodiments, this incubation is performed at 4-42° C., 6-40° C., 8-38° C., 10-36° C., 12-34° C., 14-32° C., 16-30° C., 18-28° C., 20-26° C., or 22-24° C. In some embodiments, the bone containing tissue is shaken or otherwise agitated during incubation.

In certain embodiments, after the bone containing tissue has been incubated in a primary antibody and/or stain (depending upon the protocol), unbound antibody and/or stain is removed by washing the bone containing tissue in an excess volume of washing buffer. In some embodiments, the washing buffer includes PBS (or a functional alternative). In some embodiments, the washing buffer includes 1×PBS. In some embodiments, the washing buffer is exchanged 0-20 or more, 2-18, 4-16, 6-14, or 8-10 times per day for a period of 0.1-10, 0.5-8, 1-6, 2-4, or 3 days. In some embodiments, sodium azide and/or alternative antimicrobial agents are included in the washing buffer.

In certain embodiments in which a secondary antibody is required, the primary antibody labeled (and optionally stained) bone-containing tissue can be incubated in a solution that includes a secondary antibody. In some embodiments, a secondary antibody dilution of 1:10-1000 or more, 1:20-500, 1:100-400, or 1:200-300 is used. In some embodiments, incubation in the solution containing the secondary antibody cocktail in an IHC buffer is performed for 0.01-15 days, 0.5-10 days, 1-5 days, or 2-4 days. In some embodiments, this incubation is performed at 4-42° C., 6-40° C., 8-38° C., 10-36° C., 12-34° C., 14-32° C., 16-30° C., 18-28° C., 20-26° C., or 22-24° C. In certain embodiments, Fab fragment secondary antibodies are used. In some embodiments, the PACT-deCAL cleared bone is shaken or otherwise agitated during incubation.

In certain embodiments, after the bone-containing tissue has been incubated in the secondary antibody, unbound secondary antibody is removed by washing the bone-containing tissue in an excess volume of washing buffer. In some embodiments, the washing buffer includes PBS (or a functional alternative). In some embodiments, the washing buffer is 1×PBS. In some embodiments, the washing buffer is exchanged 0-20 or more, 2-18, 4-16, 6-14, or 8-10 times per day for a period of 0.1-10, 0.5-8, 1-6, 2-4, or 3 days. In some embodiments, sodium azide and/or alternative antimicrobial agents are included in the washing buffer at this stage.

In some embodiments, one or more of the foregoing passive histology steps are performed prior to clearing the bone-containing tissue. In some embodiments, or more of the foregoing passive histology steps are performed after clearing the bone containing tissue.

### RIMS (Refractive Index Matching Solution) for PACT-deCAL Cleared Bone

Whether or not the preceding immunohistochemical labeling steps are performed, one or more RIMS, described in detail below, can be used in conjunction with PACT-deCAL cleared bone.

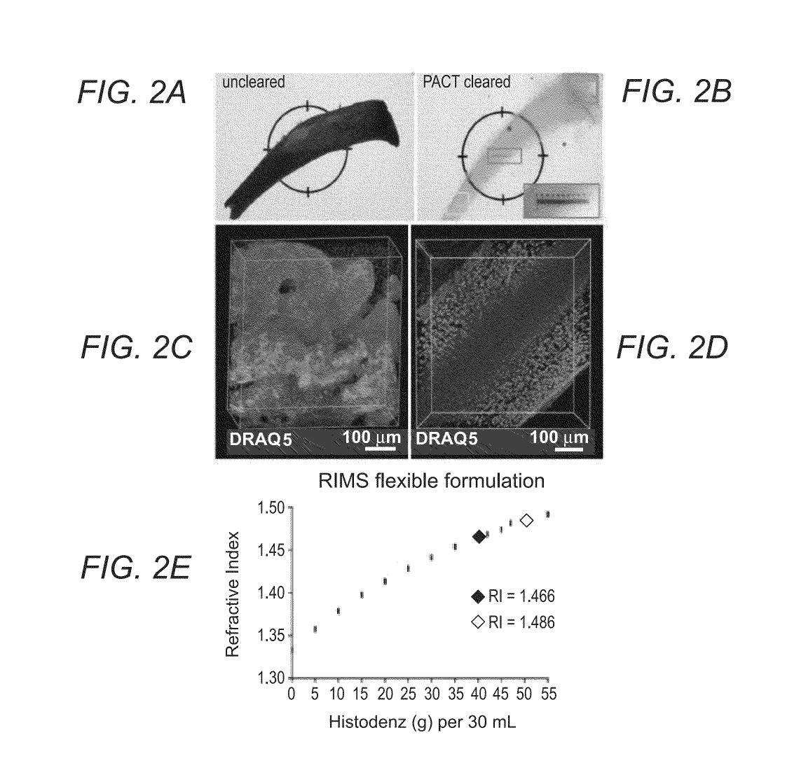

In some embodiments, the refractive index (RI) of the PACT-deCAL cleared bone is calculated by using a refractometer according to manufacturer instructions. Alternatively, the RI of the PACT-deCAL cleared bone can be approximated based on the data in FIG. 2E. A sample-optimized RIMS formulation can be prepared by adjusting the amount of Histodenz™ (or comparable alternative solution) dissolved in an appropriate buffer, which may include, but is in no way limited to PB or PBS (or functional equivalent). In some embodiments, the buffer includes 0.005-0.1 M, 0.01-0.04 M, or 0.02 M PBS. In some embodiments, the buffer includes 0.002-0.2 M, 0.005-0.15 M, 0.01-0.1 PB. In some embodiments, the buffer includes 0.02 M PB. In some embodiments, the buffer includes 0.01-0.05% sodium azide. In some embodiments, a RIMS formulation with an RI of 1.38-1.5, 1.4-1.48, or 1.48-1.49 may be used. In some embodiments a graded series of RIMS formulations is prepared, and includes formulations of RIMS with RI of approximately 1.42, approximately 1.46, and approximately 1.48-1.49. In some embodiments, the final formulation of RIMS prepared has an RI of 1.46-1.52. Approximations for these embodiments may be within ±0.01. In some embodiments, for more porous bone samples, the final formulation of RIMS prepared has an RI of 1.38-1.46.

In some embodiments, the PACT-deCAL cleared bone is processed through a graded series of RIMS incubations, with approximately 2-48 hours, 4-36 hours, 6-24 hours, 8-18 hours, or 10-15 hours at each stage. In some embodiments, the PACT-deCAL cleared bone is incubated at each stage for 24 hours. In some embodiments, the first stage is incubation in RIMS with an RI of approximately 1.42. In some embodiments, the next stage is incubation in RIMS with an RI of approximately 1.46. In certain embodiments, the final stage is incubation in RIMS with an RI of approximately 1.48-1.49. In some embodiments, the final stage is incubation in RIMS with an RI of 1.46-1.52. In some embodiments, for more porous bone samples, the final stage is incubation in RIMS with an RI of 1.38-1.46. One of skill in the art would appreciate that less than three or more than three RIMS with progressively increasing RIs could be used to achieve the final appropriate RI for the bone tissue. In some embodiments, the sample is submerged in excess RIMS and incubated at RT until it reaches the desired transparency. The time for incubation will vary depending upon the specific characteristics of the bone sample. In some embodiments, incubation times may be shortened significantly by placing samples on a nutating mixer (or other means of agitation).

In some embodiments, the PACT-deCAL cleared bone is incubated in excess RIMS at each stage at a temperature of 4-42° C., 6-40° C., 8-38° C., 10-36° C., 12-34° C., 14-32° C., 16-30° C., 18-28° C., 20-26° C., 21-23° C., or 22-24° C. until it reaches the desired transparency. In some embodiments incubation for one or more of the aforementioned stages occurs at a temperature of 20-22° C. In some embodiments, incubation may be significantly shortened by incubating on a nutating mixer or the like. In some embodiments, alternative mounting solutions can be substituted for RIMS to effectively image PACT-deCAL cleared bone, as described in the examples set forth herein. In some embodiments, RIMS treated PACT-deCAL cleared bone may be stored for three months or longer in RIMS. In some embodiments, RIMS treated samples are kept in an airtight container at 20-22° C. and protected from the light. Alternatively, when short-term storage at 4° C. is required, samples may be mounted in cRIMS (as described in the examples set forth herein) and stored in a preferably dry and preferably airtight container. In some embodiments, the RIMS treated PACT-deCAL cleared bone is allowed to equilibrate in RIMS prior to imaging when sub cellular or cellular level imaging is to be performed. In some embodiments, if coarse cellular phenotyping and/or rapid visualization is desired, then a shorter incubation may be performed. In some embodiments, sRIMS (as described in the examples set forth herein) is used instead of RIMS.

In some embodiments, the refractive-index homogenized RIMS treated PACT-deCAL cleared bone is transferred to an airtight container filled with fresh RIMS (or an alternative mounting media such as sRIMS or 87% (vol/vol) glycerol). In some embodiments, the bone sample is then degassed, by using a needle connected to a vacuum line or by another method. In some embodiments, sodium azide and/or an alternative antimicrobial substance is added to the RIMS (or alternative substance described herein)-treated PACT-deCAL cleared bone.

In some embodiments, after the RIMS treatment described above (or a comparable treatment) is performed, the PACT-deCAL cleared bone is mounted and imaged with a confocal microscope, a light sheet fluorescent microscope, a single-photon microscope, an epi-fluorescent microscope, a dissecting microscope, a wide-field fluorescence microscope with ApoTome, or another type of microscope useful for a particular desired application.

In some embodiments, to image PACT-deCAL-cleared bone-containing samples with a standard microscopy set-up (e.g. a single photon confocal microscope), a multi-immersion objective is used with a refractive index correction collar to match the RI of the mounted bone-containing sample ˜1.48-1.49. In some embodiments, for immersion media, glycerol with the same RI as the mounting RIMS is used. Optimum acquisition parameters are determined and applied. Acquisition parameters (e.g. PMT gain, laser power and scanning speed) are optimized for each sample based on the desired final image quality.

Importantly, the enhanced optical transparency of delipidized and refractive-index matched bone, achieved according to the methods described herein, permits high-resolution detection of endogenously expressed fluorescent proteins, antibody-labeled proteins, and nucleic acid transcripts at the single molecule level (FISH), usually with similar intensity and lower background signals than are seen in uncleared bone.

Although traditional antibody-based labeling methods have been used very effectively to illuminate cell phenotype and tissue morphology, they can be both cumbersome and costly. The slow penetration of full-format immunoglobulins in thick tissue necessitates long incubations, to the detriment of sample integrity. Thus, in some embodiments, camelid nanobodies and protein affinity tags present chemically stable and potentially cost-effective alternatives that can be used in conjunction with the bone-containing samples described herein. With the ability to easily penetrate thick tissue, these reagents can recognize and bind their respective targets, either a cognate antigen or tagged protein, with high specificity and rapid kinetics. Also, by using dyes that are several-fold brighter, highly photostable, and easier to separate spectrally than fluorescent proteins, protein affinity reagents can provide an excellent signal-to-noise ratio in labeled tissues.

In various embodiments, the present invention provides a kit. In some embodiments, the kit consists of, or consists essentially of, or comprises: one or more solutions and/or reagents as described herein for use in the aforementioned methods of bone clearing; and optionally instructions for using the one or more solutions and/or reagents to clear bone. In various embodiments, one, two, three, or more solutions and/or reagents described herein are provided. In some embodiment the invention teaches a kit that includes one or more, two or more, or three or more of (1) one or more components of a refractive index matching solution (RIMS), (2) ethylenediaminetetraacetic acid (EDTA) and/or ethylene glycol tetraacetic acid (EGTA), (3) acrylamide, (4) sodium dodecyl sulfate, and (5) instructions for clearing tissue comprising bone.

In some embodiments, the kit is an assemblage of materials or components, including at least one of the inventive solutions and/or reagents described above for clearing and/or visualizing bone. In some embodiments, the kit consists of, or consists essentially of, or comprises one or more of any solution and/or reagent described herein and used for clearing and/or visualizing bone.

The exact nature of the components configured in the inventive kit depends on its intended purpose. In some embodiments, the kit is configured particularly for the purpose of clearing bone.

Instructions for use may be included in the kit. “Instructions for use” typically include a tangible expression describing the technique to be employed in using the components of the kit to affect a desired outcome. Optionally, the kit also contains other useful components, such as, containers, spray bottles or cans, diluents, buffers, syringes, applicators, pipetting or measuring tools, or other useful paraphernalia as will be readily recognized by those of skill in the art.

The materials or components assembled in the kit can be provided to the practitioner stored in any convenient and suitable ways that preserve their operability and utility. For example, the solutions and/or reagents (or active portions thereof) can be in dissolved, dehydrated, or lyophilized form; they can be provided at room, refrigerated or frozen temperatures. The components are typically contained in suitable packaging material(s). As employed herein, the phrase “packaging material” refers to one or more physical structures used to house the contents of the kit, such as inventive solutions and/or reagents and/or applicators and the like. The packaging material is constructed by well-known methods, preferably to provide a sterile, contaminant-free environment. The packaging materials employed in the kit can be those customarily utilized in assays. As used herein, the term “package” refers to a suitable solid matrix or material such as glass, plastic, paper, foil, and the like, capable of holding the individual kit components. Thus, for example, a package can be a glass, plastic (or other suitable material) container used to contain suitable quantities of a reagent and/or solution as described herein. The packaging material generally has an external label that indicates the contents and/or purpose of the kit and/or its components.

One skilled in the art will recognize many methods and materials similar or equivalent to those described herein, which could be used in the practice of the present invention. Indeed, the present invention is in no way limited to the methods and materials described herein. Additional non-limiting embodiments of the invention are included in the examples below.

### EXAMPLES

### Example 1

### Tissue Preparation for PACT

A bone containing sample (“bone sample”) to be PACT processed is excised. The bone sample is post-fixed in 4% PFA for 1-2 hours at RT with gentle agitation on a rocking platform shaker. If desired, the sample can be post-fixed overnight at 4° C. Fixing samples for extended periods of time may result in over-fixation and antigen masking.

### Formation of a Tissue-Hydrogel Matrix

The polymerization of tissue components with hydrogel monomers is important as it ensures that SDS micelles preferentially solubilize and remove tissue lipids during clearing. It was previously determined that a minimal acrylamide-based network, which supports more rapid clearing, was nevertheless sufficient for stabilizing proteins and nucleic acids. To increase the level of crosslinking without the addition of bis-acrylamide or PFA to the hydrogel monomer solution, the hydrogel-infused tissue can be carried through rigorous degassing steps.

### Hydrogel-Embedding of PACT Samples

The PFA-fixed bone sample is transferred into a vacutainer or conical tube with a rubber stopper. The container is filled with ice-cold A4P0 (4% acrylamide in 1×PBS) hydrogel solution until the sample is fully submerged. The bone sample is then incubated at 4° C. overnight. The bone sample may be incubated in A4P0 at 4° C. for 3 days or more, if desired. Once placed in monomer solution, the bone sample may remain at 2-8° C. Warmer temperatures may cause premature polymerization of hydrogel monomers before they have uniformly diffused throughout the bone sample. In some embodiments, the bone sample and sample container may be purged of residual oxygen. One 4″-long hypodermic needle is inserted into the stopper so that the needle reaches near the bottom of the container, fully submerged in the hydrogel solution. A second 1″-long needle is inserted into the stopper—this needle should not touch the hydrogel solution; its sole purpose is to vent excess gas from the container to avoid pressure buildup. The hypodermic needle is connected to the nitrogen gas source and the flow of nitrogen is slowly turned on. The nitrogen gas is allowed to bubble through the hydrogel monomer solution for 1-10 minutes before turning off the flow of nitrogen and then removing both needles. To form a more rigid bone-hydrogel matrix, which can impart good tissue crosslinking and only minor slowing of clearing and immunostaining steps, a more rigorous gas-exchange step is performed. The sample container is placed on ice and a 1″-long needle is inserted into the stopper. The 1″-long needle is connected to the house vacuum line and the bone sample is degassed for 5-10 minutes, depending on the bone sample size and volume of hydrogel. The sample-container is gently tapped or briefly vortexed every minute to dislodge air bubbles from tissue. The needle is unhooked from the vacuum line, leaving the needle inserted in the stopper so that it may serve as a venting needle during nitrogen exchange. The sample-container is removed from ice, and a 4″-long hypodermic needle that is connected to the nitrogen line is inserted into the stopper, and nitrogen gas is bubbled into the hydrogel monomer solution for 5-10 minutes. The flow of nitrogen is then turned off. The degassing process (degassing the sample on ice, and then bubbling nitrogen through the hydrogel solution) may be repeated. When finished, both needles are removed. The sample container is then placed in a 37° C. waterbath for 2-3 hours. With rigorous degassing, the A4P0 solution will form a hydrogel the consistency of honey or tacky silicon sealant that is somewhat difficult to remove from the bone tissue. With 1-minute nitrogen gas exchange, the A4P0 solution will form a hydrogel the consistency of syrup that may be poured off easily.

Next, the excess hydrogel from the tissue sample is removed. Caution should be used when removing tacky hydrogel from the bone tissue. Excess hydrogel can be cut away with a scalpel or small surgical scissors and then a Kimwipe can be used to carefully remove excess hydrogel from the bone tissue. The bone sample can be briefly rinsed in 1×PBS to wash away residual syrupy-like hydrogel

Tissue Delipidation with SDS

The rate of tissue clearing depends on several parameters, including the inherent structural and biochemical properties of the tissue sample, the volume of the tissue sample, the hydrogel pore size and the density of tissue-hydrogel crosslinking, and the clearing set-up (SDS concentration, incubation temperature, pH of clearing buffer).

The following steps have been determined for clearing the dissected tibia of an adult mouse. For other bone types, it can be important to adjust the parameters of PACT-deCAL, such as the duration of bone incubations in clearing and decalcifying buffers, and the concentration of EDTA (or the use of EGTA), as described herein. Temperature fluctuations (e.g. from performing SDS or EDTA buffer changes with room temperature (RT) solutions rather than with pre-warmed 37° C. solutions, or from a water bath that is unable to maintain a constant 37° C. environment) may adversely affect bone tissue morphology.

The bone-hydrogel sample is placed into a 50 ml conical containing 10% SDS-PBS (pH 8.0) clearing buffer. The sample is gently rocked in a 37° C. shaking water bath for 2 days. The sample is transferred into 0.1 M EDTA in 1×PBS, pH 8.0, and incubated for ≧2 days in the 37° C. shaking water bath. Bone becomes soft and flexible when decalcified. Larger samples may require 6 days or longer and up to 0.5 M EDTA or more to decalcify. The EDTA-PBS is replaced with fresh 10% SDS-PBS (pH 8.0) and the sample continues to be cleared in a 37° C. shaking waterbath for 2 days. The sample is then washed in an excess volume of 1×PBS (pH 7.4) for 24 hours, and 3-4 buffer exchanges are performed. Optionally, cleared and washed samples may be stored in 1×PBS containing 0.01% sodium azide at RT for 1-2 days or more.

### Single-Cell Phenotyping of Cleared Tissues

A primary antibody cocktail is prepared in IHC buffer. An antibody dilution of 1:200-400 is used. However, a more or less concentrated antibody dilution may be used, depending on the tissue identity and bimolecular target. Passive labeling or perfusion-assisted labeling may be performed. For passive labeling schemes, a bone-containing sample should be incubated in enough of the antibody cocktail to fully bathe all surfaces. For perfusion-assisted labeling using a PARS set-up, approximately 20-100 ml primary antibody cocktail or labeling solution can be used, depending on the tissue volume to be perfused and the total volume of the perfusion system (PARS tubing volume plus an additional amount of solution to partially fill the perfusion chamber). The bone-containing sample can be incubated in the primary antibody cocktail at room temperature with shaking for 3-7 days. For small molecule stains or fluorescent dyes, a 1-3 day incubation is usually sufficient. The duration of primary antibody incubation should be determined on a case-specific basis. It is highly recommended to use smaller antibody formats for thick-tissue staining, when available. Samples are washed in an excess volume of 1×PBS buffer to remove unbound antibodies or stain. Samples can be transferred to a larger container, and 4-5 1×PBS buffer exchanges can be performed over the course of one day. If necessary, samples can be washed for 2 days or more in PBST, with 4-5 or more buffer exchanges.

A secondary antibody cocktail (1:200-400 recommended dilution) in IHC buffer can be used. Fab fragment secondary antibodies can work well. Washed bone-containing samples are incubated in the secondary antibody cocktail for 2-5 days at RT and with shaking. Labeled samples are washed with 4-5 buffer exchanges or more of 1×PBS over 1 day or more.

### RIMS (Refractive Index Matching Solutions) for PACT and PARS Bone Samples

In some embodiments the refractive index (RI) of the bone-containing sample to be mounted and imaged is calculated. In some embodiments, a refractometer is used to measure the RI of the bone-containing sample according to the manufacturer's instructions. In other embodiments, the RI is approximated based on data in FIG. 2E. A sample-optimized RIMS formulation is prepared by adjusting the amount of Histodenz™ dissolved in 0.02 M phosphate buffer. A graded series of RIMS formulations can be prepared for the bone-containing sample. In some embodiments, the cleared EDTA treated sample containing bone is serially incubated in RIMS with progressively higher RIs. In some embodiments, the final RIMS in which the bone-containing sample is incubated has an RI of 1.46-1.52. In some embodiments, RIMS with an RI˜1.42 is used as a first incubation solution, then RIMS with an RI˜1.46, and finally RIMS with an RI˜1.48-1.49, or ˜1.46-1.52. As indicated above, one of skill in the art would appreciate that less than three or more than three RIMS with progressively increasing Ms could be used to achieve the final appropriate RI for the bone tissue. In some embodiments, the sample is submerged in excess RIMS and incubated at RT until it reaches the desired transparency. The time for incubation will vary depending upon the specific characteristics of the bone sample. In some embodiments, incubation times may be shortened significantly by placing samples on a nutating mixer (or other means of agitation).

As indicated above, in some embodiments, bone is carried through a graded series of RIMS incubations, spending one day in each of RIMS-1.42, RIMS-1.46, and RIMS-1.48-9 (or ˜1.46-1.52). Bone containing samples may be stored long-term (˜3 months or more) in RIMS. In some embodiments, RIMS-submerged bone-containing samples are kept in an airtight container at room temperature and protected from light. Alternatively, when short-term sample storage at 4° C. is mandatory, bone-containing samples may be mounted in cRIMS and stored in a dry, air-tight container.

In some embodiments, the refractive-index homogenized bone-containing sample is transferred into an airtight container (e.g. vacutainers or conical with rubber stopper) and the container is filled with fresh RIMS (or with an alternative mounting media such as sRIMS or 87% (vol/vol) glycerol) until it just covers the sample. A 1″-long needle is then inserted into the rubber stopper, and the needle is connected to the house vacuum line, and the sample is degased for 5-10 minutes. Although RIMS outperforms sRIMS in some cases, the primary ingredient of sRIMS—sorbitol not only offers a cost advantage over Histodenz™, but it is also commonly available in research laboratories owing to its broad use as a cell culture reagent. Importantly, sRIMS grants very good imaging resolution. In some embodiments, for fine-scale analysis (e.g. of subcellular morphology) or lengthy image acquisition, bone-containing samples are not imaged immediately following their placement in RIMS. Instead, imaging is delayed until their initial expansion after RIMS mounting has plateaued, which may be several days or longer.

In some embodiments, cleared bone-containing samples can be mounted and imaged with a confocal microscope (or other appropriate microscope depending upon the particular desired results).

In some embodiments, to image PACT-deCAL-cleared bone-containing samples with a standard microscopy set-up (e.g. a single photon confocal microscope), a multi-immersion objective is used with a refractive index correction collar to match the RI of the mounted bone-containing sample (e.g. ˜1.48-1.49). For immersion media, glycerol with the same RI as the mounting RIMS may be used. Optimum acquisition parameters are determined and applied. Acquisition parameters (e.g. PMT gain, laser power and scanning speed) are optimized for each sample based on the desired final image quality.

### Example 2

### Reagents and Setup

### Refractive Index Matching Solution (RIMS)

Histodenz™ (Sigma-Aldrich, cat. no. D2158)
0.02 M Phosphate buffer
Sodium azide (Fisher Scientific, cat. no. 71448-16)

To prevent microbial growth, sodium azide may be added to all mounting medias (RIMS and sRIMS), as well as to all immunostaining dilutions and wash buffers that are used in extended incubations.

Sorbitol-Based Refractive Index Matching Solution (sRIMS)
70% Sorbitol (Sigma-Aldrich, cat. no. 309532)
0.02 M Phosphate buffer
Sodium azide (Fisher Scientific, cat. no. 71448-16)
   Refractive Index Matching Solution for Cold Storage (cRIMS)
Histodenz™ (Sigma-Aldrich, cat. no. D2158)
0.005 M Phosphate buffer
Sodium azide (Fisher Scientific, cat. no. 71448-16)

### Immersion Media and Alternative Mounting Media

There are numerous commercial and home-made RIMS alternatives, including FocusClear, Cargille Labs optical liquids, 2,2′-thiodiethanol, and diluted glycerol.

### Glycerol-Based Mounting Media

Glycerol (87%, vol/vol): Prepare 80-90% (vol/vol) glycerol (Sigma-Aldrich, cat. no. G5516) in dH2O.

### Immunostaining Reagents

1×PBS with Triton X-100 (0.1%, vol/vol)
Primary and secondary antibodies (as described herein)
Normal donkey serum (NDS, Jackson ImmunoResearch Laboratories, cat. no. 017-000-121)
Agarose, low melt temperature (Research Products International Corp., cat. no. 9012-36-6)

### Reagent Setup

### 0.1 M Phosphate Buffer (PB)

Add 3.1 g NaH₂PO₄ (monohydrate) and 10.9 g Na₂HPO₄ (anhydrous) in dH2O to a total volume of 1 L at pH 7.4; sterile filter and store at room temperature (18-25° C., RT) or 4° C. for up to several months. For RIMS, dilute five-fold to 0.02 M phosphate buffer, and adjust the final RIMS pH to 7.5.

### 0.01 M Phosphate-Buffered Saline (1×PBS):

Combine 8 g NaCl, 0.2 g KCl, 1.42 g Na₂HPO₄, 0.245 g KH₂PO₄ in distilled H2O (dH2O) to a total volume of 1 L; pH to 7.4, sterile filter or autoclave, and store at RT or 4° C. for up to several months. Alternatively, purchase 1×PBS mix (Sigma Aldrich, cat. no. P5368) or pre-made solution (Lonza, cat. no. 04-409R) from a commercial supplier; adjust the final pH when necessary. Use 1×PBS at pH 7.4 unless otherwise noted (e.g. in clearing buffers).

### 10×PBS Stock:

For 10 L of the 10× stock, dissolve 800 g NaCl, 20 g KCl, 144 g Na₂HPO₄ dihydrate, 24 g KH₂PO₄ in 8 L of distilled water. Add additional water to a total volume of 10 L; sterile filter or autoclave. Upon dilution to 1×PBS, the pH should approach 7.4. The pH may be adjusted with hydrochloric acid or sodium hydroxide, as needed. The resulting 1×PBS should have a final concentration of 10 mM PO₄, 137 mM NaCl, and 2.7 mM KCl. Alternatively, purchase 10×PBS pre-made solution (any, such as Lonza, cat. no. 17-517Q) from a commercial supplier.
Heparinized PBS (hPBS):
For flushing vasculature of blood at the start of perfusion, prepare 1×PBS with 0.5% sodium nitrite (wt/vol) and 10 units/ml heparin, pH 7.4. Place on ice until use or refrigerate up to a few weeks.

### 4% PFA (for Perfusion-Fixation):

To prepare 40 ml of 4% PFA (vol/vol), combine 4 ml of 10×PBS, 5 ml of 32% PFA solution and 31 ml ice-cold water. Adjust the pH to 7.4 and keep on ice or refrigerate until use (same day).

### 1×PBS Containing 0.1% Triton X-100 (Vol/Vol) (PBST):

Add 1 ml Triton X-100 to 1×PBS for a total volume of 1 L, pH to 7.4. PBST may be stored at RT for a few months when sterile-filtered; vortex or stir on a stirplate for several minutes prior to use.

### Boric Acid Buffer (BB):

Prepare a 1 M boric acid buffer stock solution through stirring 61.83 g boric acid and 10 g NaOH in 900 ml water with gentle heating. Once sodium hydroxide pellets and boric acid are fully dissolved, adjust the pH to 8.5 with NaOH and add water to a total volume of 1 L; store at RT for up to a few months. To prepare fresh borate-buffered clearing solutions, such as 8% SDS in 0.2 M BB at pH 8.5 (8% SDS-BB) for PACT and PARS, dilute 400 ml 20% SDS and 200 ml 1 M boric acid buffer stock to 1 L with distilled and deionized water (dd H2O); adjust the pH to 8.5, if necessary. To make a boric acid wash buffer (BBT, 0.2 M boric acid buffer with 0.1% Triton X-100 (vol/vol), pH 8.5), dilute the 1 M boric acid stock to 0.2 M boric acid in dd H2O, adding 1 ml of Triton X-100 per liter of BBT and stirring on a stirplate for 10 minutes. BBT may be stored at RT for several weeks, barring contamination; vortex or stir on a stirplate for several minutes prior to use.

### PACT Monomer Solution:

For rapid preparation of samples that are amenable to both standard immunohistochemistry and fluorescence imaging as well as smFISH, prepare an A4P0 hydrogel: 4% Acrylamide (0% PFA) in 1×PBS. For 200 ml of hydrogel monomer solution, add 20 ml of 40% (wt/vol) acrylamide and 20 ml of 10×PBS to 160 ml ice-cold dH2O. Stir 500 mg thermoinitiator 2,2′-Azobis[2-(2-imidazolin-2-yl)propane]dihydrochloride into ice-cold monomer solution (0.25% wt/vol final concentration). Hydrogel monomer solutions should remain cold prior to use to prevent premature polymerization. Generally prepare solutions fresh on ice, but they may be stored short-term (several hours) at 4° C. or on ice, or long-term (several months) at −20° C., protected from light.

### A4P1, A4P2, A4P4 Monomer Solutions:

To preserve a sensitive sample's structural integrity during clearing, prepare a hydrogel solution with the inclusion of 1%, 2%, or 4% PFA, respectively: 4% Acrylamide, (1%, 2%, or 4%) PFA in 1×PBS. For example, for 200 ml of A4P4 hydrogel monomer solution, add 20 ml of 40% (wt/vol) acrylamide, 25 ml of 32% PFA, and 20 ml of 10×PBS to 135 ml ice-cold dH2O. Stir 500 mg thermoinitiator 2,2′-Azobis[2-(2-imidazolin-2-yl)propane]dihydrochloride into ice-cold monomer solution (0.25% wt/vol final concentration). Hydrogel monomer solutions must remain cold prior to use to prevent premature polymerization; we generally prepare solutions fresh on ice, but they may be stored short-term at 4° C. or long-term at −20° C., protected from light.

### PACT-deCAL:

In an embodiment, combine 10 ml of 0.5 M EDTA and 40 ml of 1×PBS; adjust the pH to 8 and store at RT up to a year, barring contamination. In another embodiment, combine 20 mL of 0.5M EDTA in 30 mL of 1×PBS; adjust the pH to 8 and store at RT up to a year, barring contamination. In some embodiments, make 10% ETDA in 1×PBS at pH 8 and store at RT up to a year, barring contamination. In some embodiments, EGTA is substituted for EDTA in the same concentrations listed directly above in this “PACT-deCAL” section.

### Detergent for Tissue Clearing:

PACT-deCAL tissue clearing is accomplished via exposing tissue to a 10% SDS detergent solution. All initial validation of PACT and PARS was performed using a range of SDS concentrations (4%-16% SDS), prepared in a range of buffers (1×PBS at pH 7.5, 1×PBS at pH 8.0 (for PACT-deCAL), 1×PBS at pH 8.5, and in 0.2 M sodium borate buffer at pH 8.5). Aside from a slight clearing rate enhancement at more alkaline pH (i.e., 8% SDS-BB and 8% SDS-PBS at pH 8.5) there was no apparent trade-off in the quality or characteristics of cleared soft tissue. Thus PARS and PACT tissue clearing in 1×PBS at pH 7.5 (abbreviated 8% SDS-PBS (pH 7.5)) may hold added convenience for many users. Periodically replacing the clearing solution if it begins to acidify (i.e. monitor the clearing solution pH with pH indicator strips every 72 hours) is suggested. For PACT-deCAL, increasing the SDS concentration and clearing solution pH is suggested, as both will favor more rigorous and efficient calcium removal. The results presented in FIG. 2B were obtained using a clearing solution of 10% SDS in 1×PBS, with a final pH of 8.0 (abbreviated 10% SDS-PBS (pH 8)). It is worthwhile to note that sodium borate buffer possesses anti-microbial and anti-fungal characteristics that make it an excellent buffer for extended tissue incubations. When using 1×PBS instead of sodium borate, an appropriate antimicrobial agent should be added to the buffer (e.g. a final concentration of 0.01% sodium azide in buffer solutions). Clearing solutions are prepared fresh for each round of tissue clearing, with RT storage (up to several weeks) of excess clearing solution for buffer exchanges.

### Antibody Incubation Buffer (IHC Buffer):

The dilution of antibodies used in PACT-deCAL will be highly dependent on, among other things, the quality of the antibody, the size and tissue type of the sample to be labeled, the cellular location and concentration (i.e., expression level) of the target biomolecule, etc. A starting dilution of ˜1:200-400 is recommended and/or staining reagents in 1×PBS containing 2% normal donkey serum, 0.1% Triton X-100 and 0.01% (wt/vol) sodium azide; however, the exact antibody concentrations will need to be validated on a case-by-case basis. Prepare IHC buffer fresh.

### RIMS:

For a mounting media with RI=1.47, which is used for all samples presented here unless otherwise noted, dissolve 40 g of Histodenz™ in 30 ml sterile-filtered 0.02 M phosphate buffer. This is most easily accomplished by adding Histodenz™, phosphate buffer, and a magnetic stir bar to the final storage container (e.g. a 125 ml glass jar with lid), sealing the container to minimize evaporation and contamination, and stirring the solution on a stir-plate for approximately 10 minutes, vigorously shaking the closed jar by hand a few times during the stirring process. Once all Histodenz™ has dissolved, add sodium azide to a total concentration of 0.01% and adjust the pH to 7.5 with NaOH. RIMS may be stored at RT for several months; discard if microbial contamination occurs. Do not autoclave any solutions containing sodium azide.
sRIMS:
Prepare a 70% sorbitol (wt/vol) solution in 0.02 M phosphate buffer with 0.01% sodium azide (pH adjusted to 7.5 with NaOH); store sRIMS at RT for up to several months, barring microbial contamination. This sorbitol-based mounting media outperforms 80-90% glycerol as a refractive index matching solution for rodent brain samples. At a net cost of ˜$0.2/ml, sRIMS offers the greatest cost advantage over commercial RI matching solutions tested by the inventors, such as FocusClear, and without a sacrifice in performance.
cRIMS:
Prepare a stock buffer solution of sterile-filtered 0.005 M phosphate buffer. For a mounting media with RI=1.47, dissolve 40 g of Histodenz™ in 30 ml of this stock buffer solution; this is most easily accomplished on a stir-plate (see instructions for RIMS). Once all Histodenz™ has dissolved, add sodium azide to 0.01% and adjust the pH to 7.5 with NaOH. cRIMS may be stored at 4° C. for several months, barring microbial contamination. Samples that require short-term storage at 4° C. may be mounted in cRIMS; whereas RIMS-mounted tissue will become cloudy/turbid if placed at 4° C., the lower salt concentration of cRIMS reduces the appearance of salt precipitate at colder temperatures. Do not autoclave any solutions containing sodium azide.

The various methods and techniques described above provide a number of ways to carry out the invention. Of course, it is to be understood that not necessarily all objectives or advantages described can be achieved in accordance with any particular embodiment described herein. Thus, for example, those skilled in the art will recognize that the methods can be performed in a manner that achieves or optimizes one advantage or group of advantages as taught herein without necessarily achieving other objectives or advantages as taught or suggested herein. A variety of alternatives are mentioned herein. It is to be understood that some preferred embodiments specifically include one, another, or several features, while others specifically exclude one, another, or several features, while still others mitigate a particular feature by inclusion of one, another, or several advantageous features.

Furthermore, the skilled artisan will recognize the applicability of various features from different embodiments. Similarly, the various elements, features and steps discussed above, as well as other known equivalents for each such element, feature or step, can be employed in various combinations by one of ordinary skill in this art to perform methods in accordance with the principles described herein. Among the various elements, features, and steps some will be specifically included and others specifically excluded in diverse embodiments.

Although the application has been disclosed in the context of certain embodiments and examples, it will be understood by those skilled in the art that the embodiments of the application extend beyond the specifically disclosed embodiments to other alternative embodiments and/or uses and modifications and equivalents thereof.

In some embodiments, the terms “a” and “an” and “the” and similar references used in the context of describing a particular embodiment of the application (especially in the context of certain of the following claims) can be construed to cover both the singular and the plural. The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (for example, “such as”) provided with respect to certain embodiments herein is intended merely to better illuminate the application and does not pose a limitation on the scope of the application otherwise claimed. No language in the specification should be construed as indicating any non-claimed element essential to the practice of the application.

Preferred embodiments of this application are described herein, including the best mode known to the inventors for carrying out the application. Variations on those preferred embodiments will become apparent to those of ordinary skill in the art upon reading the foregoing description. It is contemplated that skilled artisans can employ such variations as appropriate, and the application can be practiced otherwise than specifically described herein. Accordingly, many embodiments of this application include all modifications and equivalents of the subject matter recited in the claims appended hereto as permitted by applicable law. Moreover, any combination of the above-described elements in all possible variations thereof is encompassed by the application unless otherwise indicated herein or otherwise clearly contradicted by context.

All patents, patent applications, publications of patent applications, and other material, such as articles, books, specifications, publications, documents, things, and/or the like, referenced herein are hereby incorporated herein by this reference in their entirety for all purposes, excepting any prosecution file history associated with same, any of same that is inconsistent with or in conflict with the present document, or any of same that may have a limiting affect as to the broadest scope of the claims now or later associated with the present document. By way of example, should there be any inconsistency or conflict between the description, definition, and/or the use of a term associated with any of the incorporated material and that associated with the present document, the description, definition, and/or the use of the term in the present document shall prevail.

In closing, it is to be understood that the embodiments of the application disclosed herein are illustrative of the principles of the embodiments of the application. Other modifications that can be employed can be within the scope of the application. Thus, by way of example, but not of limitation, alternative configurations of the embodiments of the application can be utilized in accordance with the teachings herein. Accordingly, embodiments of the present application are not limited to that precisely as shown and described.

What is claimed is:

1. A method, comprising:
applying a fixing solution to a tissue comprising a bone of a subject;
applying a hydrogel monomer solution to the tissue comprising the bone of the subject;
applying a detergent solution to the tissue comprising the bone of the subject; and
applying a solution comprising a calcium chelating agent to the tissue comprising the bone of the subject.

2. The method of claim 1, further comprising applying a solution comprising an amino alcohol to the tissue comprising the bone of the subject.

3. The method of claim 2, wherein the solution comprising the amino alcohol comprises N,N,N′,N′-Tetrakis(2-Hydroxypropyl)ethylenediamine.

4. The method of claim 1, wherein the calcium chelating agent comprises ethylenediaminetetraacetic acid (EDTA) and/or ethylene glycol tetraacetic acid (EGTA).

5. The method of claim 1, wherein the hydrogel monomer solution comprises 2-8% acrylamide.

6. The method of claim 1, further comprising applying a photoinitiator solution comprising 2,2′-Azobis[2-(2-imidazolin-2-yl)propane]dihydrochloride to the tissue comprising the bone of the subject.

7. The method of claim 6, further comprising
placing the tissue comprising the bone of the subject into a substantially air tight chamber, and
introducing nitrogen into the substantially air tight chamber, thereby forming a de-gassed tissue comprising bone.

8. The method of claim 1, wherein the detergent solution comprises 6-15% sodium dodecyl sulfate (SDS).

9. The method of claim 8, further comprising serially incubating the tissue comprising the bone of the subject in refractive index matching solutions (RIMS) with progressively higher refractive indexes (RIs), wherein the final RIMS in which the tissue comprising the bone of the subject is incubated has an RI of 1.46-1.52 or 1.38-1.46.

10. The method of claim 9, wherein the tissue comprising the bone of the subject is first incubated in a RIMS of a first RI, thereby forming a primary RIMS treated tissue comprising bone, and the primary RIMS treated tissue comprising bone is subsequently incubated in a second RIMS with a second RI, wherein the second RI is higher than the first RI, thereby forming a secondary RIMS treated tissue comprising bone.

11. The method of claim 10, further comprising incubating the secondary RIMS treated tissue comprising bone in a third RIMS, thereby forming a tertiary RIMS treated tissue comprising bone, wherein the third RIMS has a higher RI than the first and second RIMS.

12. The method of claim 9, wherein the first RIMS in which the tissue comprising the bone of the subject is incubated has an RI of 1.38-1.44.

13. The method of claim 12, wherein the second RIMS in which the tissue comprising bone is incubated has an RI of 1.44-1.48.

14. The method of claim 13, wherein the tissue comprising bone is incubated in a third RIMS that has an RI of 1.46-1.52 or 1.38-1.46.

15. The method of claim 1, wherein one or more of the fixing solution, hydrogel monomer solution, and detergent solution are applied to the tissue comprising the bone of the subject through the subject's vascular system.

16. The method of claim 15, wherein two or more of the fixing solution, hydrogel monomer solution, and detergent solution are applied to the tissue comprising the bone of the subject through the subject's vascular system.

17. The method of claim 15, wherein the calcium chelating agent is further applied to the tissue comprising the bone of the subject through the subject's vascular system.

18. The method of claim 1, further comprising applying a solution comprising a primary antibody to the tissue comprising the bone of the subject, thereby forming a primary antibody bound tissue comprising bone.

19. The method of claim 18, further comprising washing the primary antibody bound tissue comprising the bone of the subject with a washing solution.

20. The method of claim 19, further comprising applying a solution comprising a secondary antibody to the antibody bound tissue comprising the bone of the subject that has been washed with said washing solution, wherein the secondary antibody is labeled with a visualizable marker, thereby forming a secondary antibody bound tissue comprising bone.

21. The method of claim 20, wherein the visualizable marker is fluorescent.

22. The method of claim 18, wherein the primary antibody is labeled with a visualizable marker.

23. The method of claim 1, further comprising visualizing the tissue comprising the bone of the subject with a microscope after the detergent solution has been applied.

24. The method of claim 23, wherein the microscope is of a type selected from the group consisting of a confocal microscope, a light sheet microscope, an epi-fluorescent microscope, a dissecting microscope, and a wide-field fluorescence microscope with ApoTome.

25. The method of claim 9, further comprising using a microscope to visualize the tissue comprising the bone of the subject that has been incubated in the final RIMS.

26. The method of claim 25, wherein the microscope is of a type selected from the group consisting of a confocal microscope, a light sheet microscope, an epi-fluorescent microscope, a dissecting microscope, and wide-field fluorescence microscope with ApoTome

27. The method of claim 25, wherein a multi-immersion objective with a correction collar adjusted to match the RI of the final RIMS is used to visualize the tissue comprising the bone of the subject.

28. A kit, comprising three or more of (1) one or more components of a refractive index matching solution (RIMS), (2) ethylenediaminetetraacetic acid (EDTA) and/or ethylene glycol tetraacetic acid (EGTA), (3) acrylamide, (4) sodium dodecyl sulfate, and (5) instructions for clearing tissue comprising bone.
